(19) United States
(12) Patent Application Publication
(10) Pub. No.: US 2025/0297659 A1
(43) Pub. Date: Sep. 25, 2025

(54) TUBULAR VIBRATION ISOLATION DEVICE FOR MOTOR MOUNT

(71) Applicant: Sumitomo Riko Company Limited, Aichi (JP)

(72) Inventor: Toyoshi Setoyama, Aichi (JP)

(73) Assignee: Sumitomo Riko Company Limited, Aichi (JP)

(21) Appl. No.: 19/231,546

(22) Filed: Jun. 8, 2025

Related U.S. Application Data
(63) Continuation of application No. PCT/JP2024/002041, filed on Jan. 24, 2024.

(30) Foreign Application Priority Data
Mar. 8, 2023 (JP) 2023-035168

(51) Int. Cl. F16F 1/387; B60K 1/00; F16F 15/08

(52) U.S. Cl. CPC F16F 1/3873; B60K 1/00; F16F 15/08; F16F 2224/025; F16F 2230/02; F16F 2230/36

(57) ABSTRACT

In a tubular vibration isolation device 10, an inner shaft member 12 and an outer tubular member 14 are connected by a main rubber elastic body 16. The main rubber elastic body 16 includes a pair of rubber legs 28 connecting, on both sides of the inner shaft member in a shaft-perpendicular direction, the inner shaft member and the outer tubular member. A protrusion rubber 46 is provided, in a cut hole 40 formed by penetrating one of the pair of rubber legs 28, 28 in an axial direction, to protrude from the side of the outer tubular member to the side of the inner shaft member toward the side of the inner shaft member. The protrusion rubber is arranged as a contact rubber 56 contacting the side of the inner shaft member in a state in a vehicle mounted state.

### CROSS-REFERENCE TO RELATED APPLICATION

This application is a continuation of PCT International Application No. PCT/JP2024/002041, filed on Jan. 24, 2024, which claims priority under 35 U.S.C § 119(a) to Japanese Patent Application No. 2023-035168, filed on Mar. 8, 2023. Each of the above application(s) is hereby expressly incorporated by reference, in its entirety, into the present application.

### BACKGROUND

### Technical Field

The disclosure relates to a tubular vibration isolation device for a motor mount that supports and isolates the vibration of an electric motor for driving in an environmentally friendly vehicle, such as an electric vehicle.

### Description of Related Art

Conventionally, tubular vibration isolation devices used for power unit mounts, etc., in automobiles have been known. As disclosed in International Publication No. WO2015/045041 (Patent Document 1) and the like, the tubular vibration isolation device has a structure in which an inner shaft member and an outer tubular member are elastically connected by a main rubber elastic body.

Additionally, as shown in Patent Document 1, in the tubular vibration isolation device, a pair of clearance holes penetrating in the axial direction may be formed for purposes of adjusting the spring ratio in the shaft-perpendicular direction that intersect each other. In such case, the main rubber elastic body is configured to include a pair of rubber legs that extend toward the outer tubular member on both sides of the inner shaft member.

### PRIOR ART DOCUMENT(S)

### Patent Document(s)

Patent Document 1: WO 2015/045041

Meanwhile, in recent years, against the backdrop of the increasing concern for environmental issues, etc., environmentally friendly vehicles that adopt electric motors instead of internal combustion engines as the power source have been proposed. In some cases, the tubular vibration isolation devices are used as motor mounts for supporting electric motors.

However, internal combustion engines and electric motors differ greatly not only in the structures thereof but also in the output properties thereof, etc. Therefore, there has been a demand for a vibration isolation device that can exhibit appropriate vibration isolation performance suitable for electric motors used for driving.

Specifically, for example, compared to vibration isolation devices for internal combustion engines that only require vibration isolation performance for high-frequency (around 100 Hz) engine vibrations, vibration isolation devices for electric motors generally require vibration isolation performance for torque fluctuations up to around 1000 Hz. Therefore, when applying the conventional tubular vibration isolation device for a power unit including an internal combustion engine to a motor mount, the vibration isolation performance in the high-frequency range may be insufficient. In particular, for the motor mount, since the transmission of rubber surging of the main rubber elastic body to the vehicle in the high-frequency range becomes an issue, vibration isolation performance against rubber surging is required.

The disclosure provides a tubular vibration isolation device for a motor mount with a novel structure that can achieve improved vibration isolation performance in the high-frequency range required for the motor mount.

### SUMMARY

According to an aspect of the disclosure, in a tubular vibration isolation device for a motor mount, an inner shaft member and an outer tubular member are connected by a main rubber elastic body. The main rubber elastic body includes a pair of rubber legs connecting, on both sides of the inner shaft member in a shaft-perpendicular direction, the inner shaft member and the outer tubular member. A protrusion rubber is provided, in a cut hole formed by penetrating one of the pair of rubber legs in an axial direction, to protrude from a side of the outer tubular member to a side of the inner shaft member. The protrusion rubber is arranged as a contact rubber contacting the side of the inner shaft member in a vehicle mounted state.

### BRIEF DESCRIPTION OF THE DRAWINGS

FIG. 1 is a perspective view showing a motor mount as a first embodiment of the disclosure.

FIG. 2 is a lateral cross-sectional view of the motor mount shown in FIG. 1, corresponding to a II-II cross-section of FIG. 3.

FIG. 3 is a cross-sectional view taken along a line III-III of FIG. 2.

FIG. 4 is a view showing a portion of a IV-IV cross-section of FIG. 2.

FIG. 5 is a lateral cross-sectional view showing the motor mount of FIG. 2 in a state before pre-compression.

FIG. 6 is a lateral cross-sectional view showing the motor mount of FIG. 2 in a mounted state to a vehicle.

FIG. 7 is a front view showing a motor mount as a second embodiment of the disclosure.

FIG. 8 is a cross-sectional view taken along a line VIII-VIII of FIG. 7.

FIG. 9 is a view showing a portion of a IX-IX cross-section of FIG. 7.

FIG. 10 is a graph showing spring properties of the motor mount of FIG. 7 in the upper-lower direction.

### DESCRIPTION OF THE EMBODIMENTS

The following describes exemplary embodiments for understanding the disclosure. However, the embodiments described below are illustrative and can be appropriately combined with each other for adoption. Moreover, multiple components described in each embodiment can be recognized and adopted independently as much as possible, and can also be combined with any components described in other embodiments for adoption. As a result, in the disclosure, various alternative embodiments can be realized without being limited to the embodiments described below.

According to a first aspect, in a tubular vibration isolation device for a motor mount, an inner shaft member and an outer tubular member are connected by a main rubber elastic body. The main rubber elastic body includes a pair of rubber legs connecting, on both sides of the inner shaft member in a shaft-perpendicular direction, the inner shaft member and the outer tubular member. A protrusion rubber is provided, in a cut hole formed by penetrating one of the pair of rubber legs in an axial direction, to protrude from a side of the outer tubular member to a side of the inner shaft member. The protrusion rubber is arranged as a contact rubber contacting the side of the inner shaft member in a vehicle mounted state.

According to the tubular vibration isolation device for the motor mount with the structure following this aspect, since a cut hole is formed in one of the rubber legs of the main rubber elastic body, the rubber volume (mass) of the main rubber elastic body is reduced, and vibration due to surging of the main rubber elastic body is suppressed.

In addition, the protrusion rubber protruding from the side of the outer tubular member toward the side of the inner shaft member is provided in the cut hole, and, in a state in which the support load of the electric motor, etc., acts between the inner shaft member and the outer tubular member mounted in the vehicle, the protrusion rubber contacts the side of the inner shaft member and is arranged as a contact rubber. Therefore, the spring of the tubular vibration isolation device for a motor mount, which has been reduced due to the formation of the cut hole, is compensated by the spring of the contact rubber, allowing the spring properties to be set with a high degree of freedom. Consequently, while accurately setting the spring properties of the tubular vibration isolation device for the motor mount to meet the required properties, it is possible to suppress the vibration caused by rubber surging of the main rubber elastic body.

According to a second aspect, in the tubular vibration isolation device for the motor mount according to the first aspect, a cut hole penetrating in the axial direction is also formed in an other of the pair of rubber legs, and a protrusion rubber protruding from the side of the outer tubular member toward the side of the inner shaft member is provided at the cut hole.

According to the tubular vibration isolation device for the motor mount with the structure following this aspect, by forming cut holes in both of the pair of rubber legs, the rubber volume of the main rubber elastic body is further reduced, and the suppression of rubber surging is achieved. Moreover, since the protrusion rubber is provided in each cut hole, the reduction in spring due to the formation of the cut hole in each rubber leg is compensated by the spring of the protrusion rubbers formed in each cut hole, so the support spring stiffness and vibration isolation performance can be secured for the electric motor.

According to a third aspect, in the tubular vibration isolation device for the motor mount according to the first or second aspect, the inner shaft member has a flat outer circumferential shape, the pair of rubber legs are provided on both sides of the inner shaft member in a short direction, and in a longitudinal direction of the inner shaft member, two end portions of the inner shaft member are positioned outward with respect to both ends of the cut hole.

According to the tubular vibration isolation device for the motor mount with the structure following this aspect, the rubber legs of the main rubber elastic body are interposed between the inner shaft member and the outer tubular member in the short direction of the inner shaft member. When the inner shaft member moves relatively to the outer tubular member in the short direction, the rubber legs are compressed in the extension direction. For example, by setting the short direction of the inner shaft member as the main direction of vibration input, both the rubber leg and the contact rubber exhibit hard spring properties due to the compression spring component during the input of the main vibration. As a result, in the direction of input of the main vibration, for instance, stabilization of the support of the electric motor and effective demonstration of vibration isolation effect due to high isolation action can be expected.

According to a fourth aspect, in the tubular vibration isolation device for the motor mount according to any one of the first to third aspects, the inner shaft member has a flat outer circumferential shape, a contact surface that spreads to be orthogonal to the short direction is provided on outer circumferential surfaces on both sides of the inner shaft member in the short direction, and a protrusion tip surface of the contact rubber is brought into contact with the contact surface of the inner shaft member.

According to the tubular vibration isolation device for the motor mount with the structure following this aspect, it becomes possible to secure a sufficiently wide surface on the inner shaft member side where the protrusion tip surface of the contact rubber makes contact, by utilizing the contact surface of the outer circumferential surface of the inner shaft member. Therefore, it becomes possible to enlarge the cross-section orthogonal to the protrusion direction of the contact rubber, and to set a large spring in the protrusion direction of the contact rubber. In particular, since the contact surface spreads orthogonally to the short direction of the inner shaft member, which is the contact direction between the contact rubber and the inner shaft member side, stabilization of direct or indirect contact against the contact surface of the contact rubber is achieved.

According to a fifth aspect, in the tubular vibration isolation device for the motor mount according to any one of the first to fourth aspects, the contact rubber is arranged in a tapered shape having a width that becomes narrow in a circumferential direction toward a protrusion tip side, and an uneven shape is set at a protrusion tip portion of the contact rubber, the uneven shape being maintained without being completely collapsed the vehicle mounted state contacting the side of the inner shaft member.

According to the tubular vibration isolation device for the motor mount with the structure following the aspect, by making the contact rubber have a tapered shape, the spring constant becomes smaller at the stage where the compression deformation amount is small, and the spring increases nonlinearly as the compression deformation amount increases. Therefore, in a state where the relative displacement amount between the inner shaft member and the outer tubular member is small, improvement in ride comfort and the like can be achieved with relatively soft spring properties, while preventing the relative displacement amount between the inner shaft member and the outer tubular member from becoming excessively large, thereby ensuring the durability of the main rubber elastic body.

By setting an uneven shape in the protrusion tip portion of the contact rubber, the spring constant can be made even smaller at the stage where the compression deformation amount is small. In particular, since the uneven shape is maintained without being completely collapsed in the mounted state on the vehicle where the contact rubber is in contact with the inner shaft member side, even when the contact rubber is further compressed from the contact state with the inner shaft member side, the reduction of the initial spring due to the uneven shape is achieved. Maintaining the uneven shape without being completely collapsed not only means that the uneven shape is maintained without deformation, but may also be that the uneven shape remains even if deformed, and may also means that the tip of the contact rubber is in a state of being separated from the inner shaft member side in the concave part.

According to a sixth aspect, in the tubular vibration isolation device for the motor mount according to any one of the first to fifth aspects, the rubber leg where the cut hole is provided comprises a branch part forming wall parts on both sides of the cut hole in a circumferential direction, and the branch parts are inclined to each other and separated from each other in the circumferential direction toward an outer circumferential side, and a relative inclination angle between the branch parts is set in a range of 40° to 50°.

According to the tubular vibration isolation device for the motor mount with the structure following the aspect, the branch parts are formed in an inclined shape separated from each other towards the outer circumferential side, and the inclination angle is set to 40 degrees or more, thereby ensuring the size of the cut hole formed between the branch parts, and effectively exhibiting the suppression effect of rubber surging by reducing the rubber volume of the main rubber elastic body. Moreover, by forming a cut hole with a large circumferential width, the shape and size of the contact rubber protruding into the hole can be set with a high degree of freedom. Therefore, a high degree of freedom for tuning between the suppression effect of rubber surging and the spring properties can be obtained.

In addition, by setting the relative inclination angle of the branch parts to 50 degrees or less, a hard spring property due to the compression spring component of each branch part is effectively exhibited against vibration input in the extension direction of the rubber leg (protrusion direction of the contact rubber).

According to a seventh aspect, in the tubular vibration isolation device for the motor mount according to any one of the first to sixth aspects, the rubber leg is formed with an elastic protrusion that protrudes on an outer circumferential surface in an intermediate portion between the inner shaft member and the outer tubular member in a connection direction.

According to the tubular vibration isolation device for a motor mount with the structure following this aspect, the vibration isolation effect due to the deformation of the elastic protrusion is exhibited, thereby further reducing the vibration caused by rubber surging.

The disclosure can achieve improved vibration isolation performance in the high-frequency range required for the motor mount.

The following describes the embodiments of the disclosure with reference to the drawings.

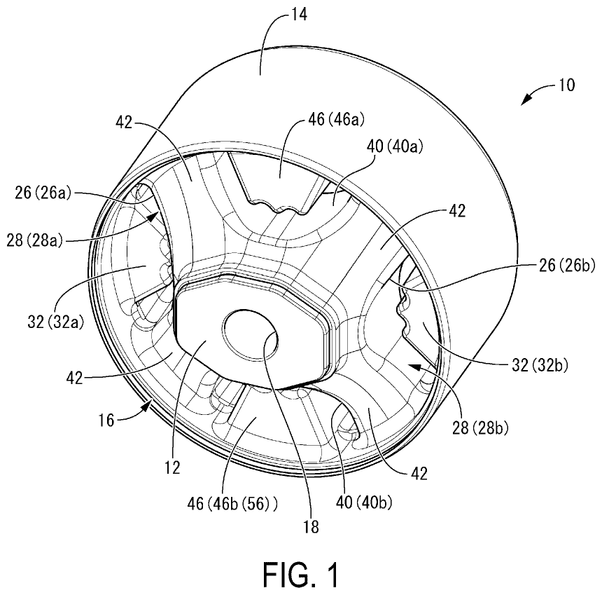

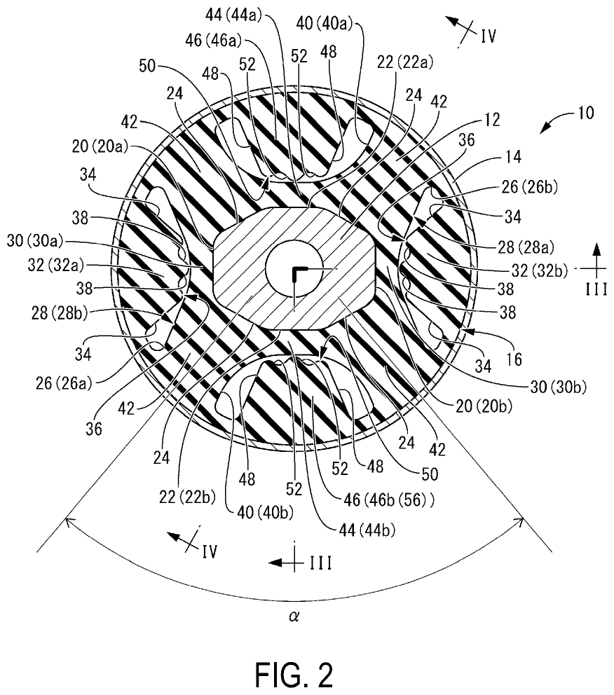

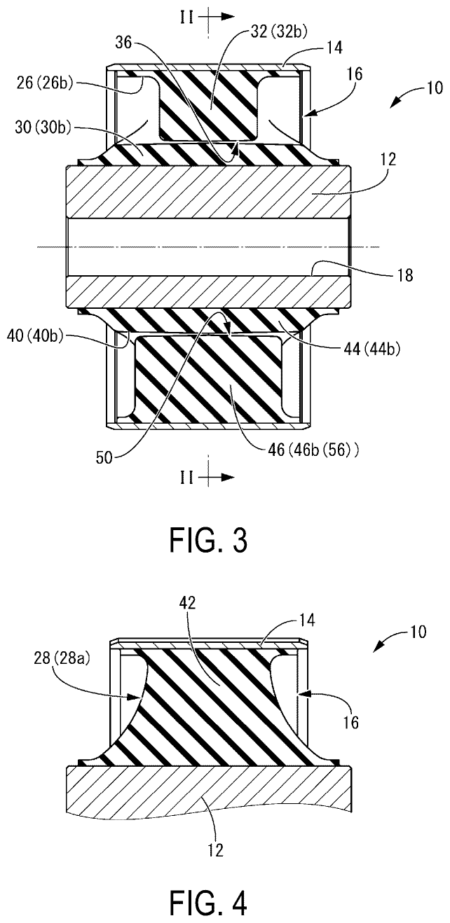

FIG. 1 to FIG. 3 show a motor mount 10 for an automobile as a first embodiment of a tubular vibration isolation device for a motor mount configured according to the disclosure. The motor mount 10 has a structure in which an inner shaft member 12 and an outer tubular member 14 are elastically connected by a main rubber elastic body 16. In the following description, in principle, the upper-lower direction refers to the vertical upper-lower direction in the vehicle mounted state, which is the upper-lower direction in FIG. 2; the left-right direction refers to the vehicle left-right direction in the vehicle mounted state, which is the left-right direction in FIG. 2; and the front-rear direction refers to the mount center axial direction, which is the left-right direction in FIG. 3.

The inner shaft member 12 is formed in a rod-like shape extending linearly with a substantially constant cross-sectional shape in the front-rear direction, and includes a mounting hole 18 that penetrates in the axial direction with a circular cross-section. In the embodiment, the inner shaft member 12, as shown in FIG. 2, has a short direction in the upper-lower direction and a longitudinal direction in the left-right direction, and has a flat outer circumferential shape (lateral cross-sectional shape) elongated in the left-right direction. The outer circumferential surface of the inner shaft member 12 includes left-right orthogonal planes 20a, 20b extending orthogonally with respect to the left-right direction, upper-lower orthogonal planes 22a, 22b extending orthogonally with respect to the upper-lower direction as contact surfaces, and inclined receiving surfaces 24, 24, 24, 24 positioned between the left-right orthogonal planes 20 and the upper-lower orthogonal planes 22 that are in adjacency in the circumferential direction. Therefore, the outer circumferential surface of the inner shaft member 12 is formed in a flat, approximately octagonal shape in a lateral cross-section.

The left-right orthogonal planes 20a, 20b constitute the surfaces on the left and right sides, respectively, of the outer circumferential surface of the inner shaft member 12, and are provided at the central portion in the upper-lower direction. The left-right orthogonal planes 20a, 20b extend in the axial direction with a substantially constant width dimension, and have an upper-lower width dimension that is equal to or greater than the diameter of the mounting hole 18.

The upper-lower orthogonal planes 22a, 22b constitute the surfaces on upper and lower sides of the outer circumferential surface of the inner shaft member 12, respectively, and are provided at the central portion in the left-right direction. The upper-lower orthogonal planes 22a, 22b extend in the axial direction with a substantially constant width dimension, and have a left-right width dimension that is equal to or larger than the diameter of the mounting hole 18.

The inclined receiving surface 24 is formed as a substantially planar surface and extends in an inclined manner with respect to both of the left-right orthogonal planes 20a, 20b and the upper-lower orthogonal planes 22a, 22b. The inclined receiving surface 24 extends at a substantially constant inclination angle, and preferably, the inclination angle with respect to the left-right direction is set to be less than 45°. The inclined receiving surfaces 24 are smoothly continuous with the left-right orthogonal planes 20a, 20b and the upper-lower orthogonal planes 22a, 22b through curved surfaces that are curved in the circumferential direction.

The outer tubular member 14, as shown in FIG. 2 and FIG. 3, is formed in a substantially cylindrical shape that is thinner-walled and larger in diameter than the inner shaft member 12. The outer tubular member 14 is formed of metal such as iron or aluminum alloy, synthetic resin such as polyamide, or the like. In the embodiment, the outer tubular member 14 is made shorter than the inner shaft member 12. However, for example, the inner shaft member 12 and the outer tubular member 14 may be of the same length, or the outer tubular member 14 may be made longer than the inner shaft member 12.

The inner shaft member 12 is inserted through the inner circumference of the outer tubular member 14, and the main rubber elastic body 16 is formed in the radial direction between the inner shaft member 12 and the outer tubular member 14. The main rubber elastic body 16 is formed as a thick tubular shape, the inner circumferential surface of the main rubber elastic body 16 is bonded to the outer circumferential surface of the inner shaft member 12, and the outer circumferential surface is bonded to the inner circumferential surface of the outer tubular member 14. The main rubber elastic body 16 is formed as an integral vulcanized molded product including the inner shaft member 12 and the outer tubular member 14, and is vulcanization-bonded to the inner shaft member 12 and the outer tubular member 14 during molding.

In the main rubber elastic body 16, first through-holes 26a, 26b are formed as clearance holes penetrating in the axial direction on both left and right sides of the inner shaft member 12. The first through-holes 26a, 26b are in a lateral cross-sectional shape having a narrower width in the circumferential direction toward the inner circumference. The inner surfaces of the first through-holes 26a, 26b are formed in tapered shapes that inclined towards the outer circumferential side from the center to both ends in the axial direction. By forming the pair of first through-holes 26a, 26b in the left-right direction, a pair of rubber legs 28a, 28b extending in the upper-lower direction are formed on both of the upper and lower sides of the inner shaft member 12 in the main rubber elastic body 16. The rubber legs 28a, 28b are provided between the inner shaft member 12 and the outer tubular member 14, and connect the inner shaft member 12 and the outer tubular member 14 with each other on both upper and lower sides of the inner shaft member 12. In the rubber legs 28a, 28b, both end surfaces in the axial direction are arranged in the tapered shape, and the axial dimension decreases from the inner circumferential side towards the outer circumferential side.

The main rubber elastic body 16 includes first cover rubbers 30a, 30b. The first cover rubbers 30a, 30b are positioned between the upper and lower portions of both left and right end parts of the pair of rubber legs 28a, 28b, and cover the left-right orthogonal planes 20a, 20b on the outer circumferential surface of the inner shaft member 12. The first cover rubbers 30a, 30b constitute the inner circumferential wall surface of the first through-holes 26a, 26b.

The main rubber elastic body 16 includes first convex parts 32a, 32b that protrude into the first through-holes 26a, 26b from the side of the outer tubular member 14 towards the side of the inner shaft member 12. As shown in FIG. 2, the first convex parts 32a, 32b have a tapered lateral cross-sectional shape that becomes narrower in the circumferential direction towards the protrusion tip. In the embodiment, the protrusion tip becomes narrower at a substantially constant rate towards the protrusion tip. Each of the side surfaces 34, 34 of the first convex parts 32a, 32b is formed as an inclined surface that is inclined to mutually diverge towards the outer circumference. Each of the side surfaces 34, 34 of the first convex parts 32a, 32b is separated from the wall surface of the first through-hole 26a, 26b, and a spaces is formed between the side surface 34 and the wall surface of the first through-hole 26a, 26b.

On the protrusion tip surface 36, which is an end surface on the inner circumferential side of the first convex part 32a, 32b, a wave-like uneven shape is set. In the embodiment, the first convex part 32a, 32b has two groove-like concave parts 38 formed in parallel, open on the protrusion tip surface 36 and extending in the axial direction. The uneven shape is set by arranging a mountain shape in which portions outside the valley-like concave parts 38, 38 protrude further towards the tip side of the first convex parts 32a, 32b than the concave parts 38, 38. The mountain-shaped part positioned between two concave parts 38, 38 protrudes further towards the inner circumferential side than the other two mountain-shaped parts.

As shown in FIG. 3, the protrusion tip surfaces 36 of the first convex parts 32a, 32b have a tapered shape that is inclined towards the outer circumferential side from the center to both ends in the axial direction. In the standalone state of the motor mount 10, as shown in FIG. 2 and FIG. 3, the protrusion tip surfaces 36 of the first convex part 32a, 32b are separated towards the outer circumferential side with respect to the first cover rubbers 30a, 30b of the main rubber elastic body 16, and face the first cover rubbers 30a, 30b in the left-right direction.

Second through-holes 40a, 40b are formed as cut holes penetrating in the axial direction in the respective rubber legs 28a, 28b of the main rubber elastic body 16. In the inner circumferential wall surfaces of the second through-holes 40a, 40b, the central portions in the left-right direction, which form the inner circumferential ends, are arranged in a flat shape that spreads to be substantially orthogonal to the upper-lower direction, and the left and right sides of the flat portions are arranged in curved shapes inclined towards the outer circumferential side as the sides proceed outward in the left-right direction. In addition, the inner circumferential surfaces of the first through-holes 26a, 26b are formed in a tapered shape that is inclined towards the outer circumferential side from the center to both ends in the axial direction.

As shown in FIG. 2, the flat inner circumferential end portions of the inner circumferential wall surfaces of the second through-holes 40a, 40b have a width dimension in the left-right direction smaller than the width dimension of the inner shaft member 12 in the left-right direction. As a result, both left and right end portions of the inner shaft member 12 protrude further outward in the left-right direction with respect to the inner circumferential end parts of the second through-holes 40a, 40b. In the embodiment, the inner circumferential end portions of the second through-holes 40a, 40b are located on the outer circumferential side of the upper-lower orthogonal plane 22 of the inner shaft member 12, and have a width dimension in the left-right direction smaller than the upper-lower orthogonal plane 22.

The second through-holes 40a, 40b are provided on both upper and lower sides of the inner shaft member 12, and the second through-holes 40a, 40b in the upper-lower direction are arranged between the first through-holes 26a, 26b in the circumferential direction. The second through-holes 40a, 40b in the upper-lower direction have a different shape from the first through-holes 26a, 26b in the left-right direction. Specifically, compared to the first through-holes 26a, 26b, the outer circumferential ends of the second through-hole s40a, 40b have a smaller circumferential dimension, and a larger radial dimension.

The rubber legs 28a, 28b are branched on both sides of the second through-holes 40a, 40b in the circumferential direction due to the formation of the second through-hole 40a, 40b, and each of the rubber legs 28a, 28b has a pair of branch parts 42, 42. The branch parts 42, 42 form the wall surfaces on both sides of the second through-holes 40a (40b) in the circumferential direction, and connect the inner shaft member 12 and the outer tubular member 14 to each other in the upper-lower direction. The branch parts 42, 42 are each inclined outward in the circumferential direction toward the outer circumference, and are in a spread state toward the outer circumference to be separated from each other in the circumferential direction. Such branch parts 42, 42 formed in a mutually inclined shape may have a relative inclination angle α set within the range of 40 to 50 degrees. As shown in FIG. 4, each branch part 42 extends continuously between the inner shaft member 12 and the outer tubular member 14, and the end part (inner circumferential end part) of each branch part 42 on the side of the inner shaft member 12 is bonded to each inclined receiving surface 24 of the inner shaft member 12. Each branch part 42 has a tapered shape where both end surfaces in the axial direction are inclined inward in the axial direction towards the outer circumference, and the axial dimension becomes smaller towards the outer circumference.

On the inner circumferential side in the rubber leg 28a, 28b with respect to the second through-hole 40a, 40b, a second cover rubber 44a, 44b is provided. The second cover rubber 44a, 44b is bonded to the inner shaft member 12 and forms a wall surface of the second through-hole 40a, 40b on the inner circumferential side. In the rubber legs 28a, 28b, the second cover rubbers 44a, 44b connect the inner circumferential end parts of the respective branch parts 42, 42 to each other in the circumferential direction, and are bonded to the upper-lower orthogonal planes 22a, 22b on the outer circumferential surface of the inner shaft member 12.

The main rubber elastic body 16 includes second convex parts 46a, 46b as protrusion rubbers protruding into the second through-holes 40a, 40b. The second convex parts 46a, 46b protrude in the upper-lower direction from the side of the outer tubular member 14 towards the side of the inner shaft member 12. The second convex parts 46a, 46b have a tapered lateral cross-sectional shape that becomes narrower towards the protrusion tip in the circumferential direction. In the embodiment, the second convex parts 46a, 46b become narrower at a substantially constant rate towards the protrusion tip. Each of the side surfaces 48, 48 of the second convex parts 46a, 46b is formed as an inclined surface that is inclined to mutually diverge towards the outer circumference. Each of the side surfaces 48, 48 of the second convex parts 46a, 46b is separated from the wall surface of the second through-hole 40a, 40b, a space is formed between the side surface 48 and the wall surface of the second through-hole 40a, 40b.

On a protrusion tip surface 50, which is an end surface on the inner circumferential side of the second convex part 46a, 46b, a wave-like uneven shape is set. In the embodiment, the second convex part 46a, 46b has two groove-like concave parts 52 formed in parallel, open on the protrusion tip surface 50 and extending in the axial direction. The uneven shape is set by arranging a mountain shape in which a portion outside the valley-like concave part 52, 52 protrudes further towards the tip side of the second convex part 46a, 46b than the concave part 52, 52. The mountain-shaped part positioned between two concave parts 52, 52 protrudes further towards the inner circumferential side than the other two mountain-shaped parts.

The protrusion tip surface 50 of the second convex part 46a, 46b has a tapered shape that is inclined towards the outer circumferential side from the center to both ends in the axial direction. In the standalone state of the motor mount 10, the protrusion tip surface 50 of the second convex part 46a, 46b is separated towards the outer circumferential side with respect to the second cover rubber 44a, 44b of the main rubber elastic body 16, and faces the second cover rubbers 44a, 44b in the upper-lower direction

In the embodiment, the second convex parts 46a, 46b protruding into the second through-holes 40a, 40b in the upper-lower direction, and the first convex parts 32a, 32b protruding into the first through-holes 26a, 26b in the left-right direction have shapes different from each other. That is, the second convex part 46a, 46b has a smaller width dimension in the circumferential direction at the base end and has a greater protrusion height dimension than those of the first convex part 32a, 32b. The width dimension in the circumferential direction at the base end of the second convex part 46a, 46b in the upper-lower direction may be smaller than the diameter dimension of the inner shaft member 12 in the longitudinal direction (left-right direction).

In addition, as shown in FIG. 3, the second convex part 46a, 46b has a greater length dimension in the axial direction than the first convex part 32a, 32b. The axial length dimension of the second convex part 46a, 46b may be set within a range of 1.2 to 2 times of that of the first convex part 32. The centers of the first convex part 32a, 32b and the second convex part 46a, 46b in the axial direction are substantially arranged at the same position, and the second convex part 46a, 46b extends further toward the outer sides in the axial direction than the first convex part 32a, 32b.

In the standalone state of the motor mount 10 shown in FIG. 1 to FIG. 3, the protrusion tip of the first convex part 32a, 32b is separated towards the inner circumferential side with respect to the inner circumferential wall surface of the first through-hole 26a, 26b, and is positioned closely to the inner circumferential wall surface of the first through-hole 26a, 26b. The distance from the protrusion tip of the first convex part 32a, 32b to the inner circumferential wall surface of the first through-hole 26a, 26b may be set within a range of 0.5 mm to 2 mm.

In the standalone state of the motor mount 10, the protrusion tip of the second convex part 46a, 46b is separated towards the inner circumferential side with respect to the inner circumferential wall surface of the second through-hole 40a, 40b, and is positioned closely to the inner circumferential wall surface of the second through-hole 40a, 40b. The distance from the protrusion tip of the second convex part 46a, 46b to the inner circumferential wall surface of the second through-hole 40a, 40b may be set within a range of 0.5 mm to 2 mm. The distance from the protrusion tip of the first convex part 32a, 32b to the inner circumferential wall surface of the first through-hole 26a, 26b and the distance from the protrusion tip of the second convex part 46a, 46b to the inner circumferential wall surface of the second through-hole 40a, 40b may be the same as or different from each other.

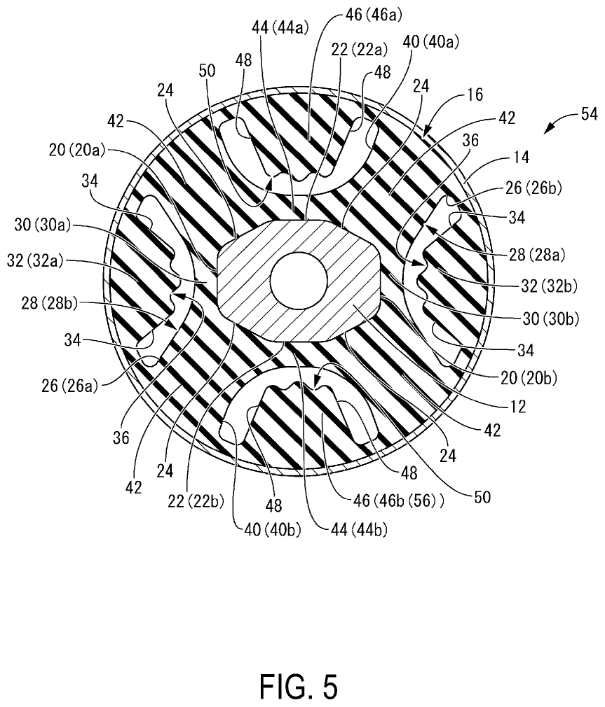

The close arrangement between the protrusion tips of the first and second convex parts 32, 46 with the inner circumferential wall surfaces of the first and second through-holes 26, 40 is realized, for example, by reducing the diameter of the outer tubular member 14 after the main rubber elastic body 16 is molded. Specifically, as shown in the integrally vulcanized molded product 54 of the main rubber elastic body 16 before reducing the diameter of the outer tubular member 14 in FIG. 5, the main rubber elastic body 16 is molded in a shape where the respective protrusion tips of the first and second convex parts 32, 46 and the wall surfaces of the first and second through-holes 26, 40 are separated more greatly. Then, by applying a diameter reduction process such as a 360-degree radial compression process to the outer tubular member 14 of the integrally vulcanized molded product 54, the protrusion tips of the first and second convex parts 32, 46 are arranged closely to the inner circumferential wall surfaces of the first and second through-holes 26, 40, thereby forming the motor mount 10 shown in FIG. 2. In this way, if the protrusion tips of the first and second convex parts 32, 46 approach the inner circumferential wall surfaces of the first and second through-holes 26, 40 through the diameter reduction of the outer tubular member 14, it becomes easier to set the separation distance between the respective protrusion tips of the first and second convex parts 32, 46 and the inner circumferential wall surfaces of the first and second through-holes 26, 40 to a small value that would have been difficult to achieve at the time of molding the main rubber elastic body 16. Furthermore, due to the diameter reduction of the outer tubular member 14, pre-compression in the extension direction is applied to the pair of rubber legs 28a, 28b of the main rubber elastic body 16, reducing tensile strain caused by cooling shrinkage after molding, thereby improving the durability of the rubber legs 28a, 28b.

In the motor mount 10 with such structure, for example, the inner shaft member 12 is attached to an electric motor side (including a power unit with the electric motor) not shown in the figure, while the outer tubular member 14 is attached to a vehicle body side also not shown in the figure. As a result, the electric motor side is supported and the vibration is isolated by the vehicle body side via the motor mount 10, and the motor mount 10 is arranged in a mounted state onto the vehicle.

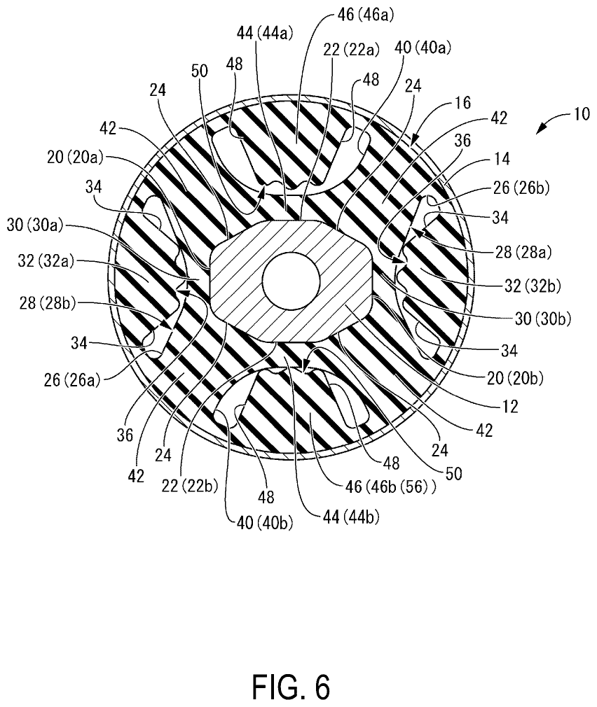

In the motor mount 10 mounted on the vehicle, the support load of the electric motor side acts between the inner shaft member 12 and the outer tubular member 14, causing the inner shaft member 12 to displace downward relative to the outer tubular member 14, as shown in FIG. 6. Then, in the mounted state of the motor mount 10 on the vehicle, the protrusion tip of the second convex part 46b on the lower side is in contact with the inner circumferential wall surface of the second through-hole 40b on the lower side, and is arranged as the contact rubber 56 in the embodiment. In other words, the protrusion tip surface of the second convex part 46b (contact rubber 56) on the lower side is in contact with the second cover rubber 44b serving as the inner circumferential wall surface of the second through-hole 40b on the lower side, and indirectly contacts the upper-lower orthogonal plane 22b on the lower side, which is the contact surface of the inner shaft member 12, through the second cover rubber 44b.

The contact rubber 56 may be pressed against the inner circumferential wall surface (second cover rubber 44b) of the second through-hole 40b and compressed in the upper-lower direction, or the contact rubber 56 may be in contact with the wall surface of the second through-hole 40b without being compressed in the upper-lower direction. The uneven shape set on the protrusion tip surface 50 of the contact rubber 56 may be maintained without the concave parts 52, 52 being completely collapsed, even if the contact rubber 56 is in contact with the side of the inner shaft member 12 in the mounted state on the vehicle. However, the uneven shape of the protrusion tip surface 50 of the contact rubber 56 does not need to be the same as the shape before contact with the side of the inner shaft member 12 (in the standalone state of the motor mount 10). For example, the shape may change while keeping the concave parts 52, 52.

In the mounted state of the motor mount 10 on the vehicle, the second convex part 46a on the upper side is separated upward with respect to the second through-hole 40a on the upper side. Due to the downward displacement of the inner shaft member 12 relative to the outer tubular member 14 caused by the support load of the electric motor side, the separation distance between the protrusion tip of the second convex part 46a and the inner circumferential wall surface of the second through-hole 40a is greater than that before the motor mount 10 is mounted on the vehicle.

In the mounted state of the motor mount 10 on the vehicle, the first convex parts 32a, 32b in the left-right direction are separated outward in the left-right direction with respect to the first through-holes 26a, 26b in the left-right direction. Due to the deformation of the main rubber elastic body 16 caused by the input of the support load of the electric motor side, the separation distances between the protrusion tips of the first convex parts 32a, 32b in the left-right direction and the wall surfaces provided on the inner sides in the left-right direction in the first through-hole 26a, 26b in the left-right direction are smaller in the upper part than that before the motor mount 10 is mounted on the vehicle and greater in the lower part than that before the motor mount 10 is mounted on the vehicle.

In the mounted state of the motor mount 10 on the vehicle, when vibration during operation of the electric motor is input between the inner shaft member 12 and the outer tubular member 14, elastic deformation of the main rubber elastic body 16 occurs, exerting a vibration isolation effect against the input vibration. As a result, the transmission of the vibration during operation of the electric motor to the vehicle body side can be suppressed, thereby improving the vibration state of the vehicle body.

Meanwhile, in motor mounts, there may be cases where improvement to the vibration state is required for higher frequency vibrations, which do not constitute an issue for engine mounts. In such case, the vibration caused by rubber surging of the main rubber elastic body may adversely affect the vibration state in the high frequency range. Therefore, in the motor mount 10 of the embodiment, the second through-holes 40a, 40b are formed in the rubber legs 28a, 28b of the main rubber elastic body 16, reducing the rubber volume of the rubber legs 28a, 28b. As a result, the frequency at which rubber surging occurs is set to a high frequency that is not problematic in practical use, and the adverse effect of rubber surging to the vehicle vibration state is reduced.

Additionally, in the motor mount 10 in which the rubber legs 28a, 28b extending in the upper-lower direction are set, there may be a case where a spring constant at the time when the vibration in the upper-lower direction in which the rubber legs 28a, 28b mainly undergo compression deformation is input needs to be larger than the spring constant at the time when the vibration in the left-right direction in which the rubber legs 28a, 28b mainly undergoes shear deformation is input. By ensuring the support spring stiffness against the electric motor side in the upper-lower direction, the displacement of the electric motor side relative to a large input such as bounce can be suppressed, while in the left-right direction where a relatively small input resulting from the left-right displacement of the electric motor side during vehicle turning takes action, good ride comfort and other benefits can be realized due to the relative soft spring property.

However, with the second through-holes 40a, 40b being formed in the rubber legs 28a, 28b, the portions of the rubber legs 28a, 28b compressed in the upper-lower direction are reduced, resulting in a smaller spring constant in the upper-lower direction. Therefore, the second convex parts 46a, 46b are provided in the second through-holes 40a, 40b, and at the time when the vibration in the upper-lower direction is input, the second convex parts 46a, 46b indirectly abut against the inner shaft member 12 through the second cover rubbers 44a, 44b. As a result, the spring of the motor mount 10 in the upper-lower direction includes not only springs of the rubber legs 28a, 28b in the upper-lower direction but also additional springs of the second convex parts 46a, 46b in the upper-lower direction. Therefore, even with the second through-holes 40a, 40b formed in the rubber legs 28a, 28b, the spring constant of the motor mount 10 in the upper-lower direction can be set to be large to secure the support spring stiffness of the electric motor side, etc.

In particular, the second convex part 46b on the lower side is configured as the contact rubber 56 that contacts the side of the inner shaft member 12 in advance in the vehicle mounting state. As a result, at the time when the downward displacement of the inner shaft member 12 with respect to the outer tubular member 14 is input, the spring acts due to the compression of the contact rubber 56, and the amount of relative displacement between the inner shaft member 12 and the outer tubular member 14 is limited. Therefore, a hard spring property in the upper-lower direction is more effectively achieved, and an additional tensile load can be prevented from excessively acting on the rubber leg 28a on the upper side which receives a static tensile load in advance due to the support load of the electric motor side, thereby ensuring the durability of the rubber leg 28a.

As described above, the motor mount 10 of the embodiment can achieve the required spring properties while preventing the deterioration of the vibration state in the high-frequency range due to rubber surging.

The rubber leg 28b has an inclination angle α of the branch parts 42, 42 branched due to the formation of the second through-hole 40b set to 50° or less, and similarly, the rubber leg 28a has an inclination angle of the branch parts 42, 42 branched due to the formation of the first through-hole 26a set to 50° or less. As a result, in each of the branch parts 42, 42 of the rubber legs 28a, 28b, the compression spring component becomes dominant relative to the vibration input in the upper-lower direction, while the shear spring becomes dominant relative to the vibration input in the left-right direction. Accordingly, it is easier to set a large spring ratio between the upper-lower direction and the left-right direction.

Furthermore, the inclination angle α of the branch parts 42, 42 constituting the rubber leg 28b is set to 40° or more, and the inclination angle of the branch parts 42, 42 constituting the rubber leg 28a is similarly set to 40° or more. As a result, it is possible to form a large second through-hole 40a (40b) between the branch parts 42, 42, and the effect of suppressing rubber surging by reducing the rubber volume of the main rubber elastic body 16 is more effectively exerted. Moreover, by ensuring the size of the second through-holes 40a, 40b, it becomes possible to set the shape, the size, etc., of the second convex parts 46a, 46b including the contact rubbers 56 protruding into the second through-holes 40a, 40b with a high degree of freedom. Therefore, it is also possible to set the rubber surging suppression effect and spring properties with a high degree of freedom. The inclination angle of the branch parts 42, 42 may change due to the deformation of the main rubber elastic body 16 caused by mounting the motor mount 10 on the vehicle, but the inclination angle may remain within the range of 40° to 50° even in the state where the motor mount 10 is mounted on the vehicle

In the motor mount 10 of the embodiment, the first convex parts 32a, 32b protrude into the first through-holes 26a, 26b formed on both left and right sides of the inner shaft member 12, and at the time when the vibration in the left-right direction is input, the first convex parts 32a, 32b come into contact with the inner shaft member 12 via the first cover rubbers 30a, 30b. As a result, the spring of the motor mount 10 in the left-right direction is contributed not only by the springs of the rubber legs 28a, 28b in the left-right direction but also by the springs of the first convex parts 32a, 32b in the left-right direction. Therefore, the spring constant in the left-right direction can be adjusted and set with a high degree of freedom by the compression spring component of the first convex parts 32a, 32b.

The respective protrusion tips of the first and second convex parts 32, 46 have uneven shapes. As a result, at the time when the first and second convex parts 32, 46 are pressed against the side of the inner shaft member 12 and compressed due to the vibration input, the spring constant (initial spring) at the stage of a small compression deformation amount is reduced. For example, the configuration may reduce the shock feeling and impact sound when the first and second convex parts 32, 46 come into contact with the side of the inner shaft member 12 from a separated state.

In the contact rubber 56 (second convex part 46b) that comes into contact with the side of the inner shaft member 12 in the mounted state on the vehicle, the uneven shape of the protrusion tip is maintained without being completely collapsed, and the contact rubber 56 is separated from the side of the inner shaft member 12 (second cover rubber 44b) in the concave part 52. Therefore, even in the contact rubber 56, the reduction of the initial spring due to the uneven shape of the protrusion tip is effectively realized.

The first and second convex parts 32, 46 have a tapered shape that becomes narrower in the circumferential direction towards the protrusion tip. Therefore, the spring constant increases non-linearly as the compression deformation amount increases. Therefore, the relative displacement amount between the inner shaft member 12 and the outer tubular member 14 in the radial direction hardly becomes excessively large, and the durability of the rubber legs 28a, 28b can be further improved.

The side surface 48 of the second convex part 46 is separated from the wall surface of the second through-hole 40, and a gap is formed between the second convex part 46 and the wall surface of the second through-hole 40 in the circumferential direction. Therefore, the second convex part 46 is allowed to bulge and deform outward in the circumferential direction accompanying the compression in the upper-lower direction, and a sudden increase in the spring constant in the upper-lower direction due to the side surface 48 of the second convex part 46 being restrained is avoided. Consequently, even if the spring of the second convex part 46 in the upper-lower direction contributes to the spring of the motor mount 10 during the input of the vibration in the upper-lower direction, shock feelings, etc., due to sudden changes in the spring are suppressed.

Likewise, the side surface 34 of the first convex part 32 is separated from the wall surface of the first through-hole 26, and a gap is formed between the first convex part 32 and the wall surface of the first through-hole 26 in the circumferential direction. Therefore, even if the spring of the first convex part 32 in the left-right direction is added to the spring of the motor mount 10 in the left-right direction, shock feelings, etc., due to sudden changes in the spring are suppressed.

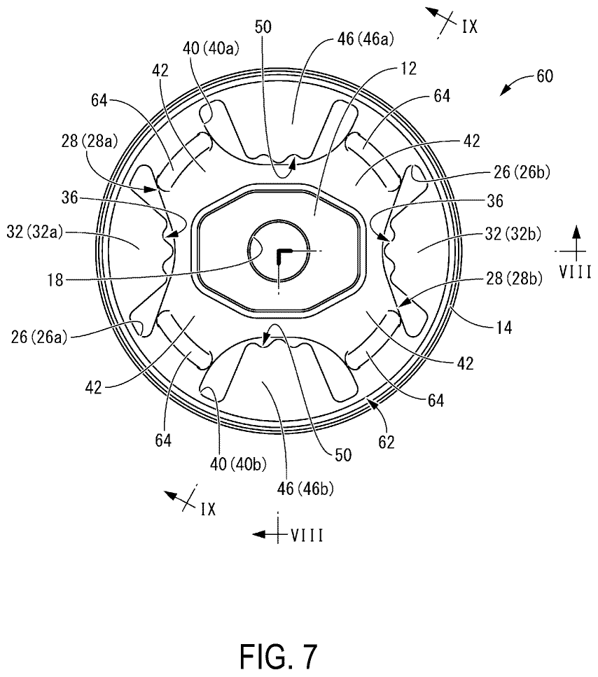

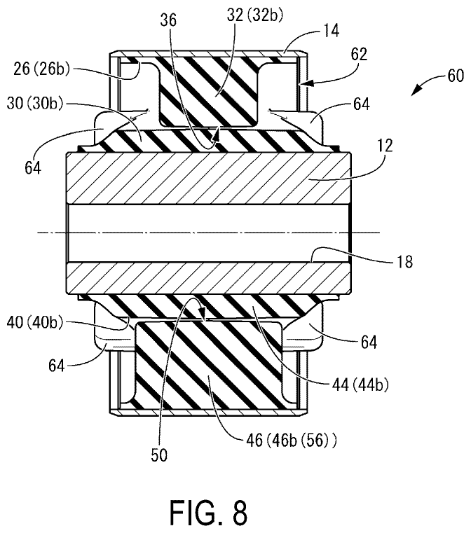

FIG. 7 to FIG. 8 show a motor mount 60 for an automobile as a second embodiment of a tubular vibration isolation device for a motor mount configured according to the disclosure. The motor mount 60 has a structure in which the inner shaft member 12 and the outer tubular member 14 are elastically connected by a main rubber elastic body 62. In the description of the embodiment, for components and parts that are substantially identical to those in the first embodiment, descriptions are omitted by assigning the same reference numerals.

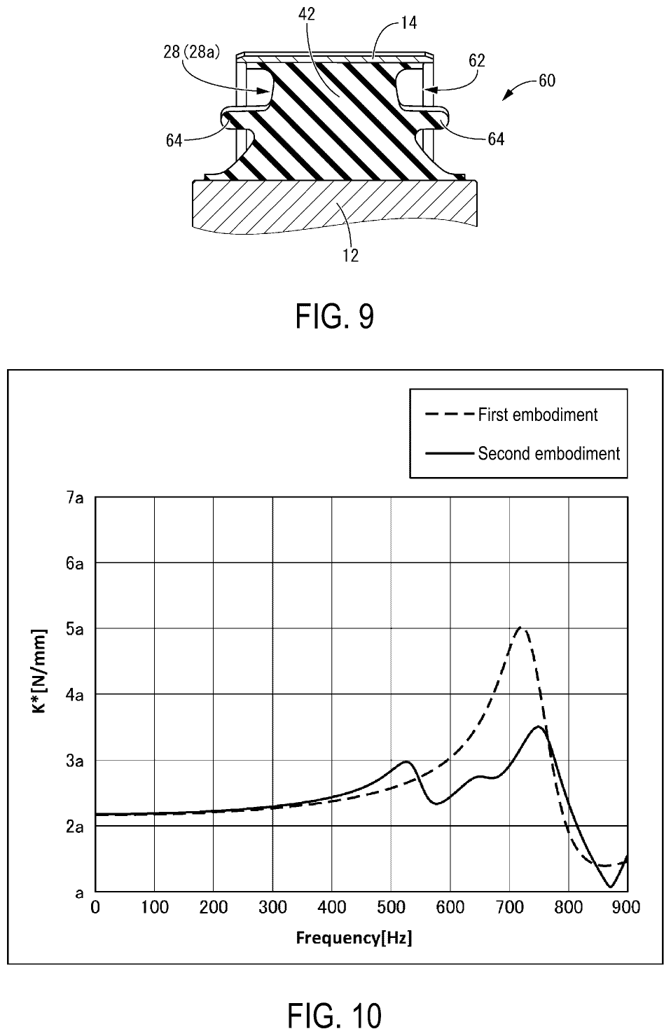

The main rubber elastic body 62 has an elastic protrusion 64 formed on each of the branch parts 42, 42 of the rubber legs 28a, 28b. The elastic protrusion 64 protrudes in the axial direction from each of the branch parts 42 and is formed in a plate shape extending in the circumferential direction. As shown in FIG. 9, the elastic protrusions 64 are integrally formed with the branch parts 42. The elastic protrusions 64 are respectively provided on both sides of the branch parts 42 in the axial direction, and are located midway in the extension direction (the direction connecting the inner shaft member 12 and the outer tubular member 14) of the branch parts 42. The elastic protrusions 64, 64 integrally formed on both sides of each of the branch parts 42 in the axial direction are arranged at positions substantially the same as each other in the radial direction and the circumferential direction.

According to the motor mount 60 including multiple elastic protrusions 64, when rubber surging occurs, a vibration isolation effect is exerted due to the deformation of the elastic protrusions 64. Therefore, in addition to the suppression effect against rubber surging by reducing the rubber volume as described in the first embodiment, the suppression effect against rubber surging by utilizing the vibration isolation effect of the elastic protrusions 64 is also exerted, and the vibration state due to rubber surging is more effectively prevented from deteriorating.

The vibration isolation effect by the elastic protrusions 64 in the motor mount 60 configured according to the embodiment is also evident from the simulation results of spring properties shown in FIG. 10. In FIG. 10, the spring properties of the motor mount 10 according to the first embodiment are shown by a dashed line, while the spring properties of the motor mount 60 related to the second embodiment are shown by a solid line. According to this, in the motor mount 60 of the second embodiment, the increase in spring constant is suppressed near 730 Hz where the spring constant becomes maximum in the motor mount 10 of the first embodiment, and the maximum value of the spring constant becomes smaller. In the simulation of FIG. 10, since the difference between the motor mount 10 of the first embodiment and the motor mount 60 of the second embodiment is only the presence or absence of the elastic protrusions 64, it can be understood that the improvement of vibration isolation performance by lowering the spring constant is achieved due to the vibration isolation effect of the elastic protrusions 64, and it is estimated that the transmission of rubber surging to the vehicle body side is more effectively suppressed by the elastic protrusions 64.

The rubber legs 28a, 28b of the main rubber elastic body 62 are formed with cut holes (second through-holes 40a, 40b), thereby reducing the mass of the rubber legs 28a, 28b. As a result, the frequency of rubber surging is set to a higher frequency, and in the region below 1000 Hz where vibration becomes an issue in practical use of automotive, as shown in FIG. 10, there is only one resonance point (peak) due to rubber surging. Therefore, by matching the resonance frequency of the elastic protrusions 64 to the frequency of the resonance point, rubber surging can be effectively reduced by the vibration isolation effect of the elastic protrusions 64. In particular, by matching the resonance frequencies of multiple elastic protrusions 64 to the frequency of the resonance point caused by rubber surging, it becomes possible to obtain a superior vibration isolation effect against rubber surging. In summary, by combining the resonance tuning effect of the rubber legs 28a, 28b by the cut holes (40a, 40b) and the vibration isolation effect by the elastic protrusions 64, the low dynamic spring properties in a wide frequency range up to 1000 Hz, which is a required characteristic of the motor mount 60 that has difficulties in achieving with conventional technology, can be achieved at an even higher level.

In the embodiment, the motor mount 60 has a configuration in which the elastic protrusions 64 are respectively formed to protrude on both sides in the axial direction in all four branch parts 42, 42, 42, 42. However, it is sufficient as long as at least one elastic protrusion 64 is provided, and it is not necessary to provide the elastic protrusions 64 in all four branch parts 42, 42, 42, 42, nor is it required to provide the branch parts 42 on both sides in the axial direction. Moreover, three or more elastic protrusions 64 may be formed for one branch part 42. For example, two elastic protrusions 64, 64 aligned in the extension direction (shaft-perpendicular direction) of the branch part 42 can be provided on both sides in the axial direction. In the case where multiple elastic protrusions 64 are provided, the elastic protrusions 64 may have different shapes and sizes from each other. For instance, the protrusion height may differ, the plate thickness dimension may differ, or the plate width dimension in the circumferential direction may also differ. Additionally, the elastic protrusions do not have to be plate-shaped and can be rod-shaped or the like. In addition, the elastic protrusions may protrude on the outer circumferential surface of the rubber leg 28 at the intermediate portion between the inner shaft member 12 and the outer tubular member 14 of the rubber legs 28 in the connection direction. For example, the elastic protrusions can be provided to protrude from the rubber legs 28 toward both sides in the circumferential direction (left-right direction, which is the width direction of the rubber legs 28).

The disclosure has been described in detail with reference to the embodiments, but the disclosure is not limited by the specific description. For example, the first convex parts 32a, 32b in the left-right direction are not necessarily required. Moreover, the first convex part 32 does not need to have a shape similar to the second convex part 46 as in the embodiments, and the first convex part 32 may have a significantly different shape from the second convex part 46. The first convex parts 32a, 32b in the left-right direction may have shapes or sizes different from each other.

The second through-holes 40a, 40b in the upper-lower direction may have different shapes and sizes from each other. Additionally, the second convex parts 46a, 46b protruding into the second through-holes 40a, 40b in the upper-lower direction may have different shapes and sizes from each other. Moreover, the second through-hole 40 and the second convex part 46 may be formed on only one of the rubber legs 28.

In the embodiments, both the rubber legs 28a, 28b in the upper-lower direction have cut holes (second through-holes 40) formed in therein, and protrusion rubbers (second convex parts 46) protrude into both of the cut holes. Among the upper and lower protrusion rubbers, only the protrusion rubber (second convex part 46b) on the lower side is designated as the contact rubber 56. However, for example, both protrusion rubbers may be designated as contact rubbers that come into contact with the sides of the inner shaft member 12 in the state of being mounted on the vehicle. In a structure where the rubber legs 28a, 28b extend in the upper-lower direction and the support load on the side of the electric motor side acts downward, at least the protrusion rubber (second convex part 46a) protruding into the cut hole (second through-hole 40a) of the rubber leg 28a on the upper side is pressed against the side of the inner shaft member 12 in the standalone state before vehicle mounting. In this way, it suffices as long as the contact rubber contacts the side of the inner shaft member 12 in the vehicle mounting state, and the contact rubber may also contact the side of the inner shaft member 12 in the standalone state before being mounted on the vehicle. Therefore, both protrusion rubbers may come into contact with the side of the inner shaft member 12 in the standalone state before being mounted on the vehicle. In such case, in the state of being mounted on the vehicle, at least one of the protrusion rubbers should maintain contact with the side of the inner shaft member 12 to serve as the contact rubber.

The uneven shape of the protrusion tip surface 50 of the second convex part 46 is not required, and the protrusion tip surface can also be constructed as a flat surface or a constant curved surface. Moreover, the uneven shape of the protrusion tip surface 50 of the second convex part 46 is not necessarily limited to a wave-like shape. For example, the protrusion tip surface 50 may be made into an uneven shape by forming spot-like concave parts that is open on the protrusion tip surface 50. The same applies to the uneven shape of the protrusion tip surface 36 of the first convex part 32.

The rubber legs 28a, 28b may have shapes and sizes differing from each other. For example, the widths in the circumferential direction or lengths in the extension direction can be made different from each other. Additionally, the branch parts 42, 42 forming the rubber leg 28 may have different shapes or sizes from each other.

The lateral cross-sectional shape of the inner shaft member 12 is not limited to the approximately octagonal shape shown in the embodiments, but may be, for example, approximately circular including elliptical, approximately polygonal other than octagonal, or irregular shapes. Moreover, the inner shaft member 12 does not necessarily need to have a flat lateral cross-sectional shape (outer circumferential surface shape), and can be, for example, a true circular shape or a regular polygonal shape.

What is claimed is:

1. A tubular vibration isolation device for a motor mount, in which an inner shaft member and an outer tubular member are connected by a main rubber elastic body,
wherein the main rubber elastic body comprises a pair of rubber legs connecting, on both sides of the inner shaft member in a shaft-perpendicular direction, the inner shaft member and the outer tubular member, and
a protrusion rubber is provided, in a cut hole formed by penetrating one of the pair of rubber legs in an axial direction, to protrude from a side of the outer tubular member to a side of the inner shaft member, and the protrusion rubber is arranged as a contact rubber contacting the side of the inner shaft member in a vehicle mounted state.

2. The tubular vibration isolation device for the motor mount as claimed in claim 1, wherein a cut hole penetrating in the axial direction is also formed in an other of the pair of rubber legs, and a protrusion rubber protruding from the side of the outer tubular member toward the side of the inner shaft member is provided at the cut hole.

3. The tubular vibration isolation device for the motor mount as claimed in claim 1, wherein the inner shaft member has a flat outer circumferential shape,
the pair of rubber legs are provided on both sides of the inner shaft member in a short direction, and
in a longitudinal direction of the inner shaft member, both end portions of the inner shaft member are positioned outward with respect to both ends of the cut hole.

4. The tubular vibration isolation device for the motor mount as claimed in claim 1, wherein the inner shaft member has a flat outer circumferential shape,
a contact surface that spreads to be orthogonal to the short direction is provided on outer circumferential surfaces on both sides of the inner shaft member in the short direction, and
a protrusion tip surface of the contact rubber is brought into contact with the contact surface of the inner shaft member.

5. The tubular vibration isolation device for the motor mount as claimed in claim 1, wherein the contact rubber is arranged in a tapered shape having a width that becomes narrow in a circumferential direction toward a protrusion tip side, and
an uneven shape is set at a protrusion tip portion of the contact rubber, the uneven shape being maintained without being completely collapsed in the vehicle mounted state contacting the side of the inner shaft member.

6. The tubular vibration isolation device for the motor mount as claimed in claim 1, wherein the rubber leg where the cut hole is provided comprises a branch part forming wall parts on both sides of the cut hole in a circumferential direction, and
the branch parts are inclined to each other and separated from each other in the circumferential direction toward an outer circumferential side, and a relative inclination angle between the branch parts is set in a range of 40° to 50°.

7. The tubular vibration isolation device for the motor mount as claimed in claim 1, wherein the rubber leg is formed with an elastic protrusion that protrudes on an outer circumferential surface in an intermediate portion between the inner shaft member and the outer tubular member in a connection direction.
